(19) United States
(12) Patent Application Publication
(10) Pub. No.: US 2024/0289681 A1
(43) Pub. Date: Aug. 29, 2024

(54) SYSTEM AND METHOD FOR PREDICTING IDEAL TIMES TO CALL

(71) Applicant: Verizon Patent and Licensing Inc., Basking Ridge, NJ (US)

(72) Inventors: Harish Babu Arunachalam, Frisco, TX (US); Tiannan Zhang, Mckinney, TX (US); Lorne George, Oviedo, FL (US)

(21) Appl. No.: 18/175,003

(22) Filed: Feb. 27, 2023

(51) Int. Cl. G06N 20/00; G06N 5/022; H04M 3/527

(52) U.S. Cl. CPC G06N 20/00; G06N 5/022; H04M 3/527

(57) ABSTRACT

A device comprises a processor. The processor is configured to: generate training vectors based on data related to communication with users; convert the training vectors into optimized vectors to be input into a machine learning unit; apply the machine learning unit to the optimized vectors to construct decision trees for determining probabilities of making a successful call during different time windows; generate a list pf calls and calling times based on the determined probabilities; and forward the list to an automatic dialer.

### BACKGROUND INFORMATION

Machine learning (ML) relates to an aspect of artificial intelligence. In contrast to systems that perform tasks based on explicit instructions (i.e., programs), an ML system may improve its performance of a task based on training data. Examples of ML systems include: a deep learning or reinforcement learning neural network; a clustering (K-means clustering) system; and a decision tree builder (e.g., a random forest building system); Examples of tasks that ML systems perform include: classifications of images; speech recognition; and controlling an autonomous vehicle.

### BRIEF DESCRIPTION OF THE DRAWINGS

FIG. 1 illustrates an exemplary network environment in which systems and methods described herein may be implemented;

FIG. 2 depicts example functional components of an intelligent calling system, according to an implementation;

FIG. 3 illustrates an example process that is associated with preparing data for a modified light gradient boosted machine (MLBGM), according to an implementation;

FIG. 4 depicts example functional components of an MLGBM, according to an implementation;

FIG. 5A illustrates example training data;

FIG. 5B illustrates example modified training data;

FIG. 5C illustrates results of computing prediction values, probabilities, and pseudo-residuals that are associated with an MLBGM, according to an implementation;

FIG. 5D illustrates an example decision tree that is constructed by an MLGBM, according to an implementation;

FIG. 6 is a flow diagram of an exemplary process associated with using an MLGBM to determine a best time to place a call, according to an implementation; and

FIG. 7 is a block diagram illustrating exemplary components of a network device.

### DETAILED DESCRIPTION OF EXAMPLE EMBODIMENTS

The following detailed description refers to the accompanying drawings. The same reference numbers in different drawings may identify the same or similar elements.

Systems and methods described herein relate to applying machine learning (ML) to predict ideal times to call. In particular the systems and the methods relate to applying computational statistics to build decision trees and using the decision trees to identify a set of ideal times to contact customers.

Providers of communication services may contact or call many customers for various reasons. For example, when a service provider may place a return call in response to a request for a solution to a technical problem. In another example, the service provider may want to present an offer of a product, a service, or upgrade options for its services. In yet another example, the service provider may want to request defaulted or delinquent customers and remind them to pay, during either self-serve call campaigns or agent campaigns. However, in all these cases, the number of calls that are picked up by the correct parties are typically low (e.g., approximately 10-20%)—only a small fraction of millions of calls. Furthermore, only a small fraction of those who pick up the calls may respond. For example. The systems and methods described herein employ a type of machine learning that relates to decision trees. In one implementation, the machine learning is implemented as a modified or Light Gradient Boosted Machine (MLGBM), to build decision trees and use the decision trees to identify ideal times to call delinquent customers, in order to increase the number of picked up calls and/or the amount of payments from the delinquent customers. In other implementations other ML methods may be used, such as a random forest, an Extreme Gradient Boost (XG Boost), an Adaptive Boost, or another decision tree method.

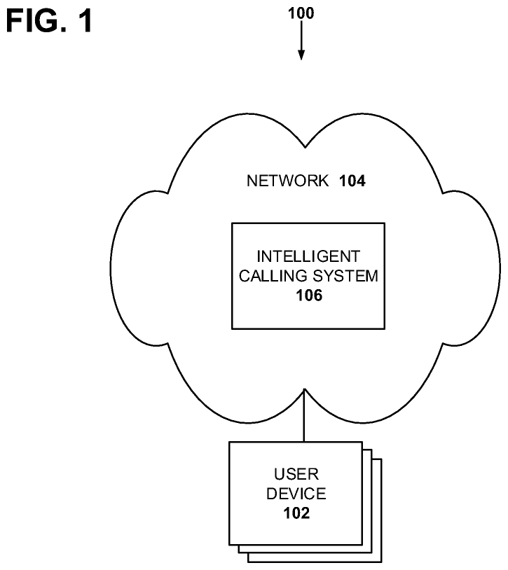

FIG. 1 illustrates the concepts described herein. As shown, a network environment 100 includes one or more of user device 102 (e.g., thousands, millions, etc.) and a network 104. User device 102 may include communication devices capable of wireline communication, Wi-Fi® communication and/or cellular communication, such as Fourth Generation (4G) (e.g., Long-Term Evolution (LTE)) communication and/or Fifth Generation (5G) New Radio (NR) communication. Examples of user devices 102 include: a fixed wireless access (FWA) device; a Customer Premises Equipment (CPE) device; a router; a modem; a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor or; and an Internet-of-Things (IoT) device with Wi-Fi® capabilities. In some implementations, user device 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices. A user of user device 102 may have subscribed to services offered by the operator of network 104. The user may have one or more accounts with network 104.

Network 104 may include one or more networks of various types. For example, network 104 may include: a Metro Ethernet (e.g., Metropolitan Area Network (MAN)); a Multi-protocol Label Switching (MPLS) network; one or more radio access networks (RANs), such as an LTE RAN and/or a 5G NR RAN, or other advanced radio networks; a core network such as a 5G core network, a 4G core network (e.g., Evolved Packet Core (EPC)), or another type of core network; a local area network (LAN); a wide area network (WAN); an autonomous system (AS) on the Internet; an optical network; a cable television network; a satellite network; a Code Division Multiple Access (CDMA) network; a general packet radio service (GPRS) network; an ad hoc network; a telephone network (e.g., the Public Switched Telephone Network (PSTN); a cellular network; a public land mobile network (PLMN); an Internet Protocol (IP network; an intranet; a content delivery network; or a combination of networks.

As further shown in FIG. 1, network 104 may include an intelligent calling system 106. Intelligent calling system 106 may include data pertaining to the users of user devices 106. Intelligent calling system 106 may identify users (also referred to as customers) who are selected to be contacted by a service provider, use the data to determine an optimal time to reach out to the users, and make calls at the determined times. In making the calls, intelligent calling system 106 may employ a type of machine learning, referred to as a MLGBM to build decision trees and use the decision trees to identify a set of time windows to contact the selected users, in order to increase the probability the users answer the calls. It should be appreciated that, in other embodiments, ML methods other than the MLGBM may be used.

For clarity, FIG. 1 does not show all components that may be included in network environment 100 (e.g., routers, bridges, wireless access point, additional networks, additional user devices 102, additional intelligent calling systems 106, etc.). Depending on the implementation, network environment 100 may include additional, fewer, different, or a different arrangement of components than those illustrated in FIG. 1. Furthermore, in different implementations, the configuration of network environment 100 may be different.

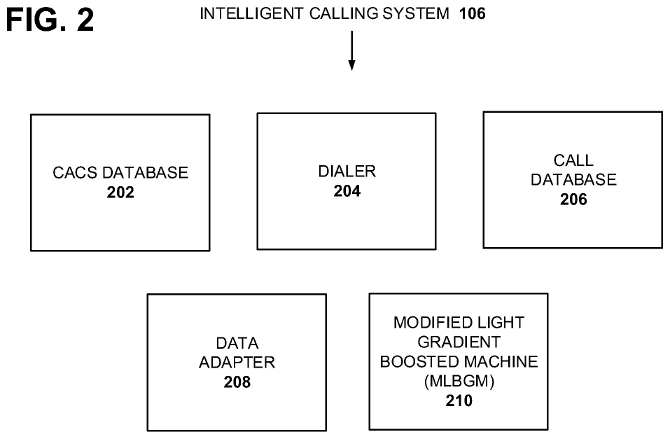

FIG. 2 depicts example functional components of intelligent calling system 106, according to an implementation. As shown, intelligent calling system 106 may include a Computer Assisted Calling System (CACS) database 202, a computer-driven dialer 204 (or simply dialer 204), a call database 206, a data adapter 208 (or simply adapter 208), and a MLGBM 210. Components 202-210 may be implemented on one or more devices, as a combination of hardware and software. Depending on the embodiment, intelligent calling system 106 may include additional, fewer, different, or a different arrangement of components than those illustrated in FIG. 2.

CACS database 202 may include records associated with users of user devices 102. Each record may include a number of attributes, such as a user credit score, a user behavior score, the last payment date, the amount delinquent, a zip code associated with the user, etc. The attribute values of a record may be assembled by data adapter 208 into raw training vectors. One particular set of attributes that may be extracted from a CACS database record to form a raw training vector are described below in greater detail. Dialer 204 may place a call to a particular user of user device 202 at a particular time specified by intelligent calling system 106. Dialer 204 may be capable of making multiple calls at one time. Dialer 204 have a queue of calls to make at scheduled times.

Call database 206 may include data records of calls made by the dialer 204. Each record in call database 206 may include information about a particular call, such as a time of the call, an identifier for a call campaign associated with the call, the calling number, the time zone associated with the called party, etc. Attributes that may be obtained from a record in call database 206 are described below in greater detail.

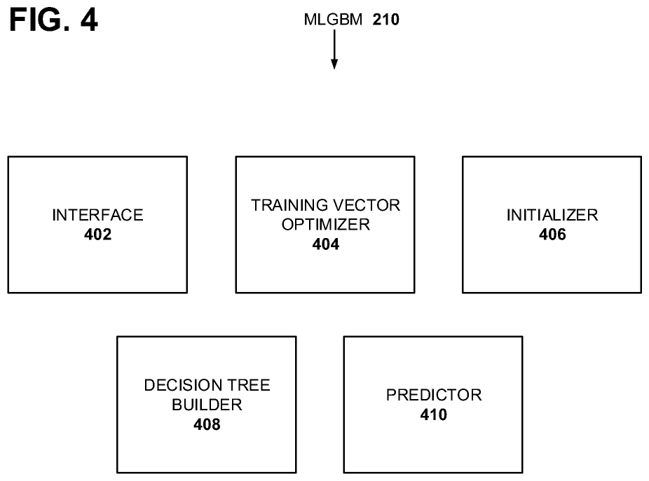

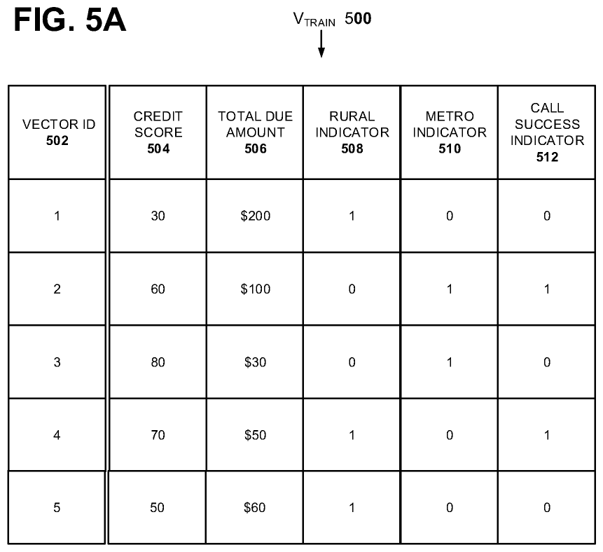

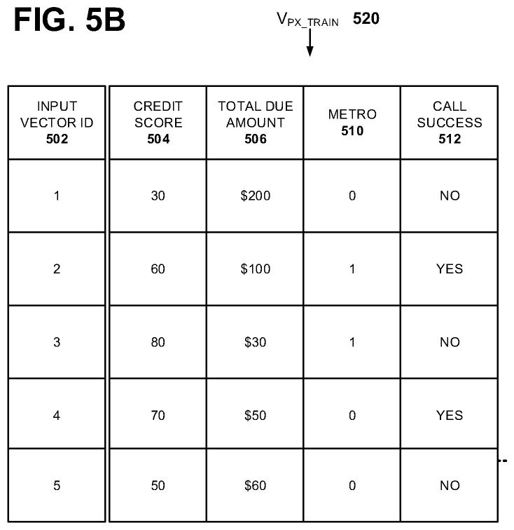

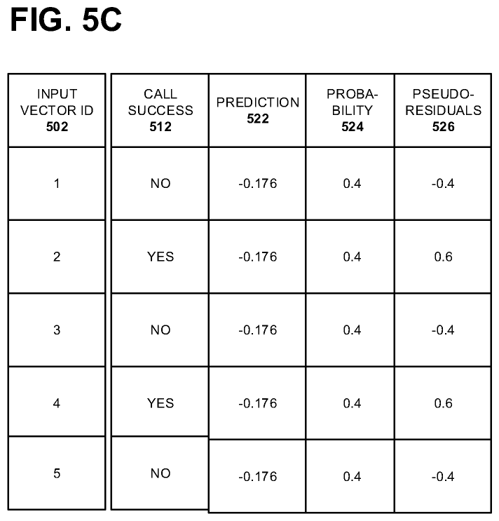

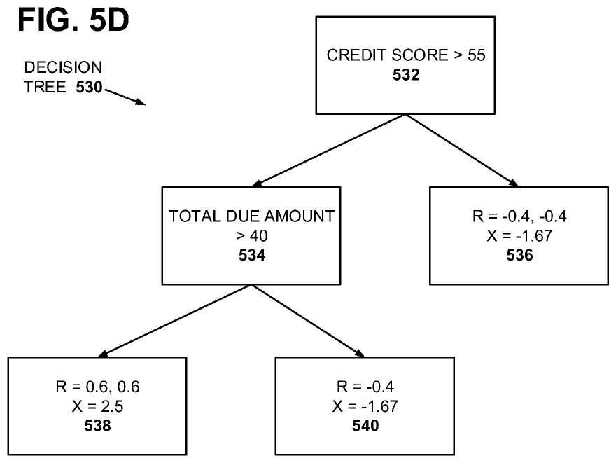

Data adapter 208 may extract raw training vectors from CACS database 202 and call database 206 and perform various operations on the raw training vectors so that the result of the operations can be input into MLGBM 210. The operations may include inserting an attribute into a vector, eliminating an attribute within a vector, splitting a vector into two separate vectors, replacing an element in a vector with another element, etc. Data adapter 208 may perform these operations to derive a set of training vectors for MLGBM 210. MLGBM 210 may apply a modified Light Gradient Boosted Machine process to determine an optimum time to call a delinquent user. As described below with reference to FIGS. 4 and 5A-5D, MLGBM 210 may apply computational statistics to build decision trees and use the decision trees to determine the optimum times for calling the delinquent users.

In a different embodiment, intelligent calling system 106 may include a different ML component in place of MLGBM 210. For example, in one embodiment, intelligent calling system 106 may include a neural network (e.g., a deep learning neural network, a reinforcement learning neural network, a convolution network, a combination of different neural networks, etc.) or another tree building machine learning component.

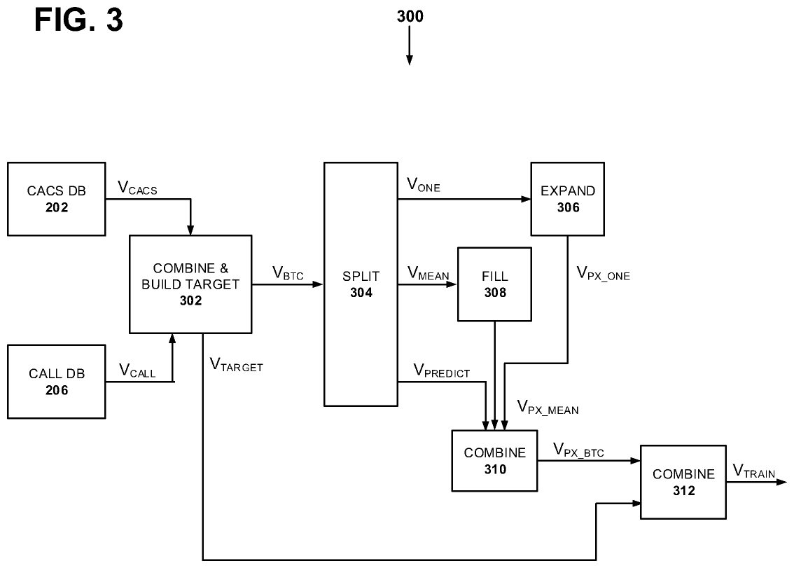

FIG. 3 illustrates an example process 300 that is performed by data adapter 208 to generate training vectors for MLGBM 210, according to an implementation. As shown, process 300 includes extracting two sets of vectors V_{CACS} and V_{CALL} from CACS database 202 and call database 206, respectively. A single vector V_{CACS} may include a 1×M matrix of numbers and/or alphanumeric characters, where M is an integer. For example, if M=2, a single V_{CACS} may have the value [1 0] with two elements. Depending on the context, V_{CACS} may denote multiple vector instances, such as [1 0], [0 1] [1], etc. In another example, assume that each vector V_{CACS} includes a credit score of a user (CREDIT_SCORE) and a last payment date (LAST_PYMNT_DT). Then, V_{CACS}=[CREDIT_SCORE LAST_PYMENT_DT] may denote either a single vector or a set of vectors having different values of CREDIT_SCORE and LAST_PYMENT_DT. In FIG. 3, each of V_{CACS} and V_{CALL} denotes a set of vector instances obtained from CACS database 202 and call database 206.

At block 302, V_{CACS} and V_{CALL} are combined to form V_{BTC}. Data adapter 208 may begin combining a V_{CACS} instance with V_{CALL} instance by identifying a V_{CALL} instance that corresponds to a particular V_{CACS} instance. Data adapter 208 may find the corresponding V_{CALL} instance by, for example, matching an identifier in the V_{CACS} instance with the same identifier in a V_{CALL} instance (e.g., the matching device ID, call number, etc.).

By combining a V_{CACS} stance and a V_{CALL} instance, data adapter 208 may generate a new vector instance V_{BTC}. The width the new V_{BTC} instance is equal to the sum of the widths of V_{CACS} and V_{CALL} and the elements of V_{BTC} comprise the elements of the V_{CACS} and V_{CALL} instances. For example, if V_{CACS}=[1 2 3 4] and V_{CALL}=[5 6], then V_{BTC}=[1 2 3 4 5 6]. Because call database 206 may include records of multiple calls made to a single user, multiple instances of V_{CALL} may exist for a single V_{CACS} instance. In such a case, a duplicate of the V_{CACS} instance may be combined with each of the multiple V_{CALL} instances. For example, if three V_{CALL} instances [0 0], [1 1], [2 2], and [3 3] were identified for a single V_{CACS}=[1 2 3 4], three V_{BTC} may be generated: [1 2 3 4 0 0], [1 2 3 4 1 1], and [1 2 3 4 2 2].

In addition to combining V_{CACS} and V_{CALL} to form V_{BTC}, at block 302, data adapter 208 may also generate V_{TARGET}. Each V_{TARGET} instance may include a one of T (an integer) possible values. Each value of V_{TARGET} instance may denote a time interval during which a call was made and the call was picked up by the correct party. In some embodiments, a value in V_{TARGET} may denote the time interval at which the call was picked up by the correct party and the call resulted in a successful outcome (e.g., defined by the intent of the call, such as a response to a survey, a selection of a product based on an offer, a payment that the party owes, etc.). For example, if a call was made in order to obtain a payment, data adapter 208 may be able to determine whether the payment was correctly made as the result of the call by examining if the payment date followed the call within a threshold time window (e.g., 2 or 3 weeks).

In one embodiment T=5, and in this instance V_{TARGET}=[TIME_INTERVAL], where TIME INTERVAL denotes one of five values 0, 1, 2, 3, and 4, where 0 indicates that a call was not picked up during any time interval, 1 indicates that an early morning call was picked up (e.g., 8 to 9:00 AM), 2 indicates that a morning call was picked up [9 to 12 noon), 3 denotes that an afternoon call was picked up (e.g., 12 noon to 4 PM), and 4 indicates that an evening call was picked up (e.g., 4 to 9 PM). In other embodiments, T may be different and/or each value of TIME INTERVAL may denote a different time interval.

Process 300 may further include splitting each V_{BTC} instance into three vector instances: a V_{ONE_HOT_ENCODED_FEATURES} instance (shown in FIG. 3 and referred to as V_{ONE}); a V_{MEAN_ENCODED_FEATURES} instance (shown in FIG. 3 and referred to as V_{MEAN}), and a V_{PREDICT} instance. Data adapter 208 may split a V_{BTC} instance by grouping the elements of the V_{BTC} instance into three groups and placing each group in a different vector instance. For example, if V_{BTC}=[1 2 3 4 5 6], V_{BTC} may be split into V_{ONE}=[1 2], V_{MEAN}=[3 4] and V_{PREDICT}=[5 6]. Depending on the embodiment, data adapter 208 may split V_{BTC} in different ways.

At block 306, V_{ONE} (resulting from the split at block 304) may be expanded into a larger vector V_{PX_ONE}. For example, assume that V_{ONE}=[01], where the single element 01 denotes a category. If there are four possible categories (e.g., 00, 01, 11, and 10), then V_{ONE} can be expanded to V_{PX_ONE}=[0 1 0 0], where the first, second, third and fourth elements correspond to each of the values representing one of the four categories. In some implementations, data adapter 208 may expand V_{ONE} into V_{PX_ONE} so that when data adapter 208 forms V_{TRAIN} using V_{PX_ONE} (as well as other vectors), V_{TRAIN} permits MLGBM 210 (or another AML component) to optimize its computation.

At block 308, data adapter 208 may fill any missing datum in a V_{MEAN} instance (resulting from the split at block 304) to generate V_{PX_MEAN}. During the splitting of V_{BTC} at block 304, attributes that can have missing values/data are selected from V_{BTC} to and placed in V_{MEAN}. For example, assume that there are three instances of V_{BTC}=[1 2 3], [4 5 6], and [8 1 X], with X denoting a missing datum. V_{MEAN} is then formed by selecting column 3 of V_{BTC} instances, resulting V_{MEAN}=[3], [6], and [X]. The third instance of V_{MEAN} is missing a datum. Data adapter 208 may fill the missing datum at block 308, with an average value of the instances of V_{MEAN}. In this example, the average value is (3+6)/2=4.5. Accordingly, data adapter 208 may fill the missing datum in the third V_{MEAN} instance with 4.5, to obtain V_{PX_MEAN}=[3], [6], and [4.5], with 4.5 replacing X.

At block 310, data adapter 208 may combine V_{PREDICT}, V_{PX_MEAN}, and V_{PX_ONE} to generate V_{PX_BTC}. Data adapter 208 may combine V_{PREDICT}, V_{PX_MEAN}, and V_{PX_ONE} in a manner similar to the manner in which V_{CACS} and V_{CALL} are combined to produce V_{BTC} at block 302. That is, the attributes of V_{PX_BTC} are the attributes of V_{PREDICT}, V_{PX_MEAN}, and V_{PX_ONE}. For example, if V_{PREDICT}=[1 2 3], V_{PX_MEAN}=[4 5] and V_{PX_ONE}=[6, 7], then V_{PX_BTC}=[1 3 4 5 6 7]. In a different embodiment, data adapter 208 may arrange the elements in the resulting vector instance V_{PX_BTC} in a different order. At block 312, data adapter 208 may combine V_{PX_BTC}, with V_{TARGET}, to generate V_{TRAIN}. In a manner similar to the manner in which vector instances are combined at block 302 and/or 310.

FIG. 4 depicts example functional components of a MLGBM 210, according to an implementation. As shown, MLGBM 210 may include an interface 402, a training vector optimizer 404, an initializer 406, a decision tree builder 408 (also referred to as builder 408), and a predictor. Components 402-410 may be implemented on one or more devices as a combination of hardware and software. Depending on the embodiment, MLGBM 210 may include additional, fewer, different, or a different arrangement of components than those illustrated in FIG. 4.

Interface 402 may include components (e.g., APIs, an interface to a portal, etc.) for allowing a client application installed on another device to interact with MLGBM 210 and control its operation. For example, interface 402 may permit the client application to input MLGBM parameters, such as the number of leaves to be generated for each decision tree (to be described further below), a number of decision trees, the size of a gradient constant, indications of whether a particular attribute in an input vector is to be merged with another attribute or expanded into multiple attributes, and/or any modifications to a gradient-based one-sided sampling (GBOSS) (to be described below). A user may also specify, via interface 402, whether MLGBM 210 is to provide its results to dialer 204 and how MLGBM 210 is to drive dialer 204 to place calls to delinquent users. For example, in one implementation, a user may set, via interface 402, parameters for MLGBM 210 to generate 100 decision trees, each tree having 31 leaves and 6 layers-though other parameters are contemplated. In a different implementation, the parameters may be selected using a grid search.

Training vector optimizer 404 may modify input training vectors (V_{TRAIN}) to optimize the operation of MLGBM 210 for efficiency. By modifying V_{TRAIN}, MLGBM 208 may meet the criteria for obtaining the desired solution, more quickly or with less computation. Training vector optimizer 404 may modify the V_{TRAIN}, for example, by eliminating one or more attributes of V_{TRAIN}.

FIG. 5A illustrates an example training data set, whose V_{TRAIN} may be optimized by training vector optimizer 404 may modify. As shown, training vectors V_{TRAIN} 500 are shown as a table, where each row corresponds to a V_{TRAIN} instance. As shown, each V_{TRAIN} instance may be identified by a vector ID 502 and may include the following attributes: a credit score 504, a total due amount 506, a rural indicator 508, a metro indicator 510, and a call success indicator 512. Depending on the implementation each V_{TRAIN} instance may include additional, fewer, different, or a different arrangement of attributes than V_{TRAIN} instances shown in FIG. 5A.

Credit score 504 may indicate the credit score of a subscriber of network 104. In FIG. 5A, the numerical values of credit score 504 have been normalized to 100, with 100 indicating the best possible score and 0 indicating the lowest possible score. Total due amount 506 may indicate the total overdue amount that the subscriber of network 104 owes to the service provider. Rural indicator 508 may indicate whether the subscriber resides in a rural area, and metro indicator 510 may indicate whether the subscriber resides in a metro area. Call success indicator 512 indicates whether a prior call made to the subscriber was a success (e.g., either the call was picked up by the subscriber or was picked up by the subscriber who made a payment to the service provider within an allotted period of time after the call).

Referring back to FIG. 4, when training vector optimizer 404 analyzes different attributes of V_{TRAIN}, training vector optimizer 404 may determine which attributes (or column) are redundant based on information provided by other attributes. For example, the values of rural indicator 508 is a logical complement of metro indicator 510. Whenever the value of rural indicator 508 in V_{TRAIN} is zero, the value of metro indicator 510 in the V_{TRAIN} instance is one. Accordingly, all the information that is conveyed by rural indicator 508 in a V_{TRAIN} instance is also provided by metro indicator 510 in the same V_{TRAIN} instance. Accordingly, training vector optimizer 404 may eliminate either rural indicator 508 or metro indicator 410 in V_{TRAIN} 500.

Depending on the analysis, it is also possible that both rural indicator 508 and metro indicator 510 do not provide any information with respect to the values of call success 512. In such a case, training vector optimizer 404 may remove both attributes 508 and 510 from V_{TRAIN} 500. FIG. 5B illustrates an example modified training data set V_{PX_TRAIN} 520, which results from eliminating rural indicator 508 and metro indicator 510 from V_{TRAIN} 500. Although V_{PX_TRAIN} 520 includes fewer attributes than V_{TRAIN} 500, V_{PX_TRAIN} 520 includes the same information as V_{TRAIN} 500. By using V_{PX_TRAIN} 520 rather than V_{TRAIN} 500, MLGBM 210 may handle less data and therefore spend less computational resources to arrive at a desired result.

Referring back to FIG. 4, initializer 406 may set the starting values for MLGBM 210 to begin its computations to determine best times to contact the delinquent subscribers. In some implementations, initializer 406 may determine, for each vector instance V_{PX_TRAIN}, the following: a predicted value U (also herein referred to as a prediction U); a probability P associated with the prediction; and what is referred to as a pseudo-residual R. To compute the prediction U for each V_{PX_TRAIN} instance, initializer 406 may first determine overall odds of obtaining a particular outcome (e.g., of making a successful call) based on the training data (all of the V_{PX_TRAIN} instances and take the logarithm (or log) of the odds.

To illustrate, assume that initializer 406 receives V_{PX_TRAIN} 520 of FIG. 5B, Initializer 406 first computes the odds of making a successful call. To compute the odds, initializer 406 may determine, for V_{PX_TRAIN} 520, the number of entries with YES values (indicating a successful call) and the number of entries with NO values in the column corresponding to call success indicator 512. Initializer 406 then divides the number of YESs by the number of Nos. In FIG. 5B, there are two YESs and three Nos-hence the odds are 2/3. Taking the log (2/3) yields the predicted value U of −0.176. FIG. 5C illustrates the result of computing the predictions for the V_{PX_TRAIN} 520 of FIG. 5B. As shown in FIG. 5C, entries of column 522 include the predictions for each of V_{PX_TRAIN} instances. Although all of the predictions are set to the value of −0.176 by initializer 406, as MLGBM 210 iterates through its computation, the predication U for each V_{PX_TRAIN} instance may become different from the predictions of other V_{PX_TRAIN} instances.

In addition to determining a prediction U for each V_{PX_TRAIN} instance, initializer 406 may also determine a probability P associated with the prediction U. In some implementations, each probability P may be computed by determining the following expression for the corresponding V_{PX_TRAIN} instance:

$$P = 10 \hat{} U / ( 1 + 10 \hat{} U ) . \qquad ( 1 )$$

FIG. 5C illustrates the result of computing the probabilities for V_{PX_TRAIN} 520 of FIG. 5B. As shown, each V_{PX_TRAIN} instance includes the probability P=10\hat{ }(−0.176)/(1+10\hat{ }(−0.176))=0.4. Although the probabilities for all of the V_{PX_TRAIN} instances have the same value, in the subsequent computations, the probability P for each V_{PX_TRAIN} may become different from probabilities for other V_{PX_TRAIN} instances as MLGBM 210 iterates over V_{PX_TRAIN} 520 until MLGBM 210 meets a stop condition (e.g., the number of computational cycles=a threshold, an error is smaller than a specified amount, an improvement in predictions are smaller than a threshold, etc.).

In addition, initializer 406 may determine, for each V_{PX_TRAIN} instance, a pseudo-residual R. A pseudo-residual may be roughly interpreted as a distance between an observed outcome and a probability P (e.g., an error value). Initializer 406 may compute a pseudo-residual R for each V_{PX_TRAIN} instance by evaluating the following expression:

$$R = Observed outome - P . \qquad ( 2 )$$

For example, as shown in FIG. 5B, call success 512 values (the observed outcomes) for the V_{PX_TRAIN} instances having vector IDs of 1 to 5 are denoted by NO, YES, NO, YES, and NO, which have numerical values of 0 1 0 1 0. Thus, for the V_{PX_TRAIN} instance having the vector ID of 1, its pseudo-residual is given by R=0−0.4=−0.4. In another example, for the V_{PX_TRAIN} instance having the vector ID of 2, its pseud-residual is given by R=(1−0.4)=0.6. FIG. 5C illustrates the result of computing the pseudo-residuals for all of the V_{PX_TRAIN} instances of FIG. 5B.

Returning to FIG. 4, decision tree builder 408 may build a particular number of decision trees (e.g., specified via interface 402) or build decision trees until a criterion for stop building trees is met (e.g., a change in an outcome (to be described below) due to a newly constructed decision tree is smaller than a threshold). When a decision tree builder 408 constructs a decision tree, builder 408 associates a test condition (e.g., >, <, =, etc.) with an internal node (e.g., a node that is not a root or a leaf) corresponding to a particular attribute of V_{PX_TRAIN} instance. For example, a condition that a value of credit score 504 (FIG. 5B)>T1 may be associated with a decision node; and a condition that a value of total due amount 506 (FIG. 5B)>T2 may be associated with another decision node. From a decision node, two branches (or arrows) may originate, one pointing to the left and the other pointing to the left. At the end of a branch (or an arrow) is either a decision node or an end node (also referred to as a leaf node or a leaf) may be present. Each leaf node may be assigned a residual by applying training vectors to the decision nodes, as further described below.

FIG. 5D illustrates decision tree 530 with 3 layers. Decision tree 530 may be constructed by using two decision nodes and three leaves. The decision nodes include a decision node 532, which corresponds to the condition total credit score >T1, and a decision node 534, which corresponds to the condition total due amount >T2, where T1=55 and T2=40. By applying V_{PX_TRAIN} instance to each decision node, beginning at the root (the top-most decision node in a decision tree) and following, at each decision node, the arrow to the left (if the condition at the decision node is satisfied) or to the right (if the condition at the decision node is not satisfied), MLGBM 210 may traverse the decision tree for each V_{PX_TRAIN} instance. For example, assume that a V_{PX_TRAIN} instance has the vector ID of 1 (see FIG. 5B). At root 532, the condition is credit score >55. Since the V_{PX_TRAIN} instance of vector ID=1 has the credit score 504 of 30, MLGBM 210 may traverse decision tree 530 from root 532 to leaf 536. At leaf 536, MLGBM 210 may record the pseudo-residual R of the V_{PX_TRAIN} instance. That is, leaf 536 has the pseudo-residual R of the V_{PX_TRAIN} that traversed decision tree 530 to leaf 536.

In another example, assume that a V_{PX_TRAIN} instance has the vector ID of 2 (see FIG. 5B). At node 532, the condition is credit score >55. Since the V_{PX_TRAIN} instance of vector ID=2 has the credit score 504 of 60, MLGBM 210 traverses decision tree 530 from root 532 to decision node 534. At node 534, the condition is total due amount >40. Since the V_{PX_TRAIN} instance of vector ID=2 has the total due amount 506 of 100, MLGBM 210 traverses decision tree 530 from decision node 534 to a leaf 538. At leaf 538, MLGBM 210 records the pseudo-residual R of the V_{PX_TRAIN}. MLGVM 210 may apply each of the V_{PX_TRAIN} instances to decision tree 530, assigning pseudo-residuals at each of the leaves. Because there are many V_{PX_TRAIN} instances in V_{PX_TRAIN} 520, each leaf may be assigned more than one pseudo-residual R. For example, leaf 536 has a single pseudo-residual R of −0.4; leaf 538 has two pseudo-residuals R of 0.6 and 0.6; and leaf 540 has a single pseudo-residual R of −0.4.

When decision tree builder 408 constructs a decision tree, decision tree builder 408 may attempt to select a particular arrangement of the decision nodes and various thresholds for each of the decision nodes, such that the sum of the square of the pseudo-residuals at the leaves of the decision tree is minimized. For example, for decision tree 530, different thresholds T1 and T2 may be used for decision nodes 532 and 534, decision nodes 532 and 534 may be arranged differently (e.g., node 534 may be at the root), and/or different decision nodes (e.g., the condition for branching may be different), if such an arrangement and thresholds yield a minimum sum of the squares of the pseudo-residuals for the entire decision tree. In addition, when constructing a decision tree, decision tree builder 408 may adhere to constraints specified by a user, such as the number of leaves per tree, and the number of layers.

After decision tree builder 408 determines the pseudo-residuals for each leaf, decision tree builder 408 may finish building the particular tree by calculating an output value X (or simply output X) for each of the leaves. An output X for a leaf may be computed by evaluating the following expression:

$$X = \frac{{\sum }_{i}^{N} {R}_{i}}{{\sum }_{i}^{N} {P}_{i} ( 1 - {P}_{i} )} . \qquad ( 3 )$$

In expression (3), Rᵢ denotes an i^{th} pseudo-residual R at the leaf; Pᵢ denotes a previously computed probability for the i^{th} residual; and N denotes the number of pseudo-residuals R at the leaf. For example, for leaf 536, output X=−0.8/(0.8(1−0.4))=−1/0.6=−1.67. Similarly, at leaf 538, output X=1.2/(0.8(1−0.4))=2.5; and at leaf 540, output X=−1.67.

Returning to FIG. 4, predictor 410 may use the outputs X of the leaves to determine a next set of predictions U, probabilities P, and pseudo-residuals R for each of the V_{PX_TRAIN} instance. That is, predictor 410 may refine the result by using previous output. Predictor 410 may compute the next prediction by evaluating the following expression:

$$U = {U}_{P} + Learning - Rate \cdot {X}_{P} . \qquad ( 4 )$$

In expression (4), U may denote the current prediction (to be determined by expression (4)), U_{P} may denote the previously determined prediction, and X_{P} may denote the previously computed output X for the leaf, which has been assigned the pseudo-residuals associated with the particular V_{PX_TRAIN} instances. The learning rate may have been preset or may be calculated to modify the prediction U at a relatively small increment. For example, for the V_{PX_TRAIN} instance with the vector ID of 1, the previous prediction is illustrated in FIG. 5C as −0.176. Applying the V_{PX_TRAIN} instance to decision tree 530 leads to leaf 536 whose output X is −1.67. Assuming that the learning rate has been preset to 0.1, evaluating expression (4) for the V_{PX_TRAIN} instance yields U=−0.176+0.1·(−1.67)=−0.343. Predictions U for other V_{PX_TRAIN} instances may be computed similarly.

When evaluating expression (4) for V_{TRAIN} instances, predictor 410 may apply gradient-based one sided sampling (GOSS). In GOSS, to save time and computational resources, predictor 410 limits its computations to a subset of V_{TRAIN} instances. Predictor 408 may select the subset by selecting, from the original set, more V_{TRAIN} instances with a large output X than those with smaller output X. By limiting its computations to the subset of the V_{TRAIN} instances, predictor 410 dedicates most of its computational resources and time to V_{TRAIN} instances that lead to the largest improvements to the predictions.

After updating the prediction U for each of the V_{TRAIN} instances in the subset based on expression (4), predictor 410 may evaluate the corresponding probability P for each of the V_{PX_TRAIN} instances in the subset by applying expression (1) to the new prediction U. Thereafter, predictor 410 may determine, for each of the V_{PX_TRAIN} instances in the subset, a new pseudo-residual R, by applying expression (2).

After predictor 410 performs its computations for the current decision tree, if decision tree builder 408 determines that a new decision tree is needed, decision tree builder 408 may build a new decision tree based on the original set of V_{TRAIN} instances. The new decision tree may have the same configuration or a different configuration, which may be obtained by minimizing the most up-to-date pseudo-residuals for the leaves. After the new decision tree is complete (i.e., the outputs for the leaves are computed), predictor 410 may reselect a subset of V_{TRAIN} instances to evaluate the next generation of new predictions based on expression (4), new probabilities based on expression (1), and new pseudo-residuals based on expression (2). Decision tree builder 408 and predictor 410 may continue to operate in tandem, to build new decision trees and make corresponding calculations until one or more criteria are met for terminating the tree-building/prediction cycles.

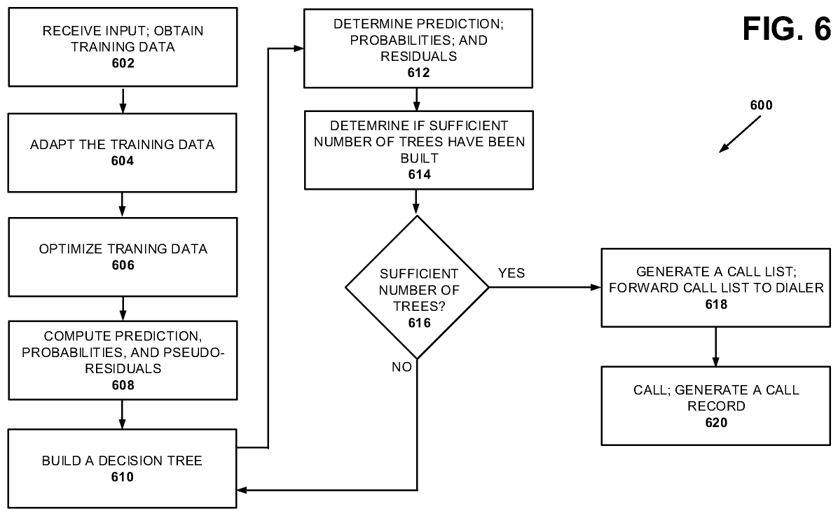

FIG. 6 is a flow diagram 600 of an exemplary process that is associated with using MLGBM 210 to determine a best time to call a user, according to an implementation. Process 600 may be performed by intelligent calling system 106 and/or user devices 102. As shown, process 600 may include receiving user input via, for example, interface 402 of MLGBM 210. The input may designate particular MLGBM parameters for determining the best time to call. The parameters may include, for example: the number of leaves for decision trees that are to be constructed; whether a particular optimization is to be applied in constructing decision trees; whether MLGBM 210 is to eliminate, when possible, a particular attribute of training vector instances; and when MLGBM 210 is to stop constructing decision trees and stop further computation. After the input, intelligent calling system 106 may obtain or receive data from databases, such as CACS database 202 and call database 206 in the form of training vectors, such as V_{CACS} and V_{CALL}.

As indicated above, depending on the implementation, training vectors obtained from CACS database 202 and call database 206 may include different attributes. In one example implementation, a V_{CACS} instance (herein referred to as V_{CACS1} for this example) may include values for the following attributes: ACCT_OPEN_DT, ACCT_TYPE_CD, BEHAVIOR_SCORE, BILL_CYCLE_IND, CACS_ENTRY_DT, CACS_FNCTN_CD_2ND_1, CATS_CREDIT_SCORE, COLL_STATUS_CD, CREDIT_CLASS, CREDIT_SCORE, CURR_DUE_AMT, CUST_ZIP_CD, DEVICE_TYPE_CD, INSTANCE_IND, LANG_PREF_IND, LAST_ACTIVITY_DT, LAST_BRKN_PROMISE_DT, LAST_CNTCT_ACTIVITY_DT, LAST_COLLCTR_USER_ID, LAST_KEPT_PROMISE_DT, LAST_PYMNT_DT, LAST_UPD_DT, MKT_CD, NEXT_DUE_DT, NUM_ATTEMPT, NUM_BRKN_PROMISE, NUM_CELL_ACTIVE, NUM_LETTER_SENT, PENDING_PROMISE_DT_1, PENDING_PROMISE_DT_2, PENDING_PROMISE_HOLD_DT, PRI_CACS_STATE_NUM, PROMISE_TAKEN_DT, RELATIVE_RISK_SCORE, STATE_ENTRY_DT, TOT_DELINQ_AMT, and TOT_DUE_AMT. Depending on the implementation, V_{CACS} may include additional, fewer, or different attributes than those listed above.

ACCT_OPEN_DT may indicate an account activation date. ACCT_TYPE_CD may identify the type of account for the account holder. BEHAVIOR_SCORE may indicate a quantitative measure of behavior of an account holder. BILL_CYCLE_IND may indicate a bill cycle day assigned to a customer account. CACS_ENTRY_DT may denote the date on which the account was created in the CACS. CACS_FNCTN_CD_2ND_1 may indicate a second functional area in which the account holder may reside. CATS_CREDIT_SCORE may indicate the type of credit risk associated with the account holder. COLL_STATUS_CD may include a code that identifies the status of the mobile devices on the account. CREDIT_CLASS may denote a customer credit class. CREDIT_SCORE may indicate the customer credit score.

CURR_DUE_AMT may indicate the current amount due on the account. CUST_ZIP_CD may include the customer zip code. DEVICE_TYPE_CD may indicate the device type associated with the account. INSTANCE_IND may indicate the billing system. LANG_PREF_IND may indicate a preferred language for the account holder. LAST_ACTIVITY_DT includes the date of the last activity on the account. LAST_BRKN_PROMISE_DT includes the date of the last broken promise for the account. LAST_CNTCT_ACTIVITY_DT denotes the date of the most recent contact with the account holder. LAST_COLLCTR_USER_ID may represent the identity of the last collector contacted by the user. LAST_KEPT_PROMISE_DT may include the date of the last promise which was kept for the account.

LAST_PYMNT_DT includes the date of the last payment. LAST_UPD_DT includes the date on which the record was last updated. MKT_CD may indicate a basic geographic dimension for reporting (e.g., miles). NEXT_DUE_DT may indicate the next date on which payment is due for the account. NUM_ATTEMPT may indicate the number of credit card holder lines for the account. NUM_BRKN_PROMISE may denote the number of broken promises by the account holder. NUM_CELL_ACTIVE may denote the total number of active cells for the account. NUM_LETTER_SENT may indicate the number of letters sent by the CACS to the account holder.

PENDING_PROMISE_DT_1 may indicate a date by which the account holder promised to make the first payment (e.g., a promised mailing date of the first payment). PENDING_PROMISE_DT_2 may signify the date by which the account holder promised to make the second payment (e.g., a promised mailing date for the second payment). PENDING_PROMISE_HOLD_DT may denote an internal date used by the CACS to determine when the account promise should be considered broken. PRI_CACS_STATE_NUM may indicate a current work state number of the account. PROMISE_TAKEN_DT may include the date on which the most recent promise was obtained for the account. RELATIVE_RISK_SCORE may indicate a relative risk score for the account holder. STATE_ENTRY_DT may denote the date on which the account entered its current CACS work state. TOT_DELINQ_AMT may indicate the total delinquent amount. TOT_DUE_AMT may indicate the total amount due.

In another example of training vectors obtained from CACS database 202 and call database 206, V_{CALL} (herein referred to as V_{CALL1} for this particular example) may include values for the following attributes: RECORD_ID, CALL_START_TIME, IMPORT_DATE, LAST_UPDATE_TIMESTAMP, TZ, and CAMPAIGN_ID. RECORD_ID may indicate an identifier for the record from which the vector instance was obtained. CALL_START_TIME may indicate the start time of the call associated with the record. IMPORT_DATE may include the time of importing the record into call database 206. LAST_UPDATE_TIMESTAMP may include a timestamp for the last update of the record. TZ may indicate a time zone associated with the called party. CAMPAIGN_ID may indicate an identifier for the collection campaign associated with the call. In a different implementation, V_{CALL} may include different attributes.

Referring back to FIG. 6, process 600 may further include adapting or modifying the training data for MLGBM 210. For example, each V_{CACS} instance and V_{CALL} instance may be combined to produce a V_{BTC} instance in the manner described for block 302. In addition, V_{TARGET} instances may be generated in the manner also described for block 302. For example, if V_{CACS}=V_{CACS1} (described above) and V_{CALL}=V_{CALL1}, the attributes of V_{TARGET} for the example may include V_{TARGET1}=[EARLY_MORNING MORNING AFTERNOON EVENING, NONE], with the attributes EARLY_MORNING, MORNING, AFTERNOON, EVENING, and NONE respectively indicating an early morning call, a morning call, an afternoon call, an evening call, and no call described above.

Each V_{BTC} instance may then be split into V_{ONE}, V_{MEAN}, and V_{PREDICT} at block 304 as shown in FIG. 3. For example, assuming V_{CACS}=V_{CACS1} and V_{CALL}=V_{CALL1}, V_{ONE} may be set to, for example, V_{ONE1}=[COLL_STATUS_CD INSTANCE_IND LANG_PREF_IND]; V_{MEAN} may be set to V_{MEAN1}=[ACCT_TYPE_CD BILL_CYCLE_IND CREDIT_CLAS DEVICE_TYPE_CD MKT_CD PRI_CACS_STATE_NUM TZ CUST_ZIP_AREA_CD ZIPCODE]; and V_{PREDICT} may be set to V_{PREDICT1}=[CACS_ENTRY_DT_DAYS IMPORT_DAY_OF_WEEK IMPORT_MONTH INSTANCE_IND IMPORT_WEEK MKT_CD LAST_CNTCT_ACTIVITY_DT_DAYS LAST_ACTIVITY_DT_DAYS NUM_ATTEMPT CREDIT_SCORE CATS_CREDIT_SCORE BEHAVIOR_SCORE ACCT_TYPE_CD LANG_PREF_IND COLL_STATUS_CD NUM_LETTER_SENT NUM_CELL_ACTIVE NUM_BRKN_PROMISE LAST_PYMNT_DT_DAYS RELATIVE_RISK_SCORE POPULATION MEDIAN_HOME_VALUE MEDIAN_HOUSEHOLD_INCOME OCCUPIED_HOUSING_UNITS ACCT_OPEN_DT_DAYS TZ BILL_CYCLE_IND DEVICE_TYPE_CD CUST_ZIP_5_LETTER PRI_CACS_STATE_NUM CREDIT_CLASS TOT_DUE_AMT CURR_DUE_AMT TOT_DELINQ_AMT].

V_{ONE} (e.g., V_{ONE1}) may then be expanded to generate V_{PX_ONE} and V_{MEAN} (e.g., V_{MEAN1}) may be filled to generate V_{PX_MEAN}, in ways similar to those described above for blocks 306 and 308. V_{PREDICT}, V_{PX_MEAN}, and V_{PX_ONE} may be combined at block 310 to produce V_{PX_BTC}. V_{PX_BTC} may then be further combined with V_{TARGET}, to generate V_{TRAIN}.

Process 600 may further include optimizing V_{TRAIN} to be input into MGLBM 210 (block 606). The optimization, for example, may eliminate one or more attributes of V_{TRAIN} that do not convey useful information to MLGBM 210 in identifying best times to contact the delinquent customers. By optimizing V_{TRAIN}, MLGBM 210 may generate V_{PX_TRAIN}.

Process 600 may further include computing prediction, probabilities, and pseudo-residuals for V_{PX_TRAIN} instances (block 608). For example, as described above with reference to FIG. 4, initializer 406 may compute the initial predictions, the corresponding probabilities, and the pseudo-residuals for the V_{PX_TRAIN} (e.g., a V_{PX_TRAIN} that would results from processing V_{CACS1} and V_{CALL1} rather than V_{PX_TRAIN} 520). Based on the pseudo-residuals, decision tree builder 408 may construct a decision tree (block 610). In contrast to decision tree 530, however, in process 600, the decision tree may include a different number of nodes and leaves (e.g., 31 leaves). Furthermore, each decision node of the decision tree may include conditions different from the conditions in decision nodes 532 and 534 of decision tree 530.

Process 600 may further include generating the next set of predictions, probabilities, and pseudo-residuals for the decision tree (block 612) in a manner similar to those described with respect to FIG. 3 but for V_{PX_TRAIN} instances obtained at block 604. At block 614, MLGBM 210 may determine whether a sufficient number of decision trees have been built for determining the best times to call the users (bock 614). For example, MLGBM 210 may have been instructed to construct no more than 100 decisions trees. If the number of constructed decision trees is 100, MLGBM 210 may determine that a sufficient number of trees have been constructed. In another example, to determine whether a sufficient number of decision trees have been constructed, MLBM 210 may determine whether the latest decision tree has resulted in an insignificant update to the probability associated with making a successful call to a user at a particular time (e.g., <a threshold).

If a sufficient number of decision trees have not been constructed (block 616: NO), process 600 may return to block 610 to construct another tree using the most up-to-date predictions U, probabilities P, and pseudo-residuals R and to make further computations. If a sufficient number of trees have been constructed (block 616: YES), process 600 may proceed to block 618.

Process 600 may further include generating a call list based on the computed probabilities for making a successful call at a particular time window for each of the V_{PX_TRAIN} instances (block 618). For example, if a particular V_{PX_TRAIN} instance is associated with a probability (of successful call) higher than a threshold (e.g., 15%), MLGBM 210 may include the user ID, the contact phone number, and the designed call time in the call list. After generating the call list, MLGBM 210 may forward the call list to dialer 204 (block 618). In response to receiving the call list, dialer 204 make each of the calls identified in the call list at scheduled times (block 620). In addition, dialer 204 may record data that is associated with each call and store the data in call database 206. The call data may include, for example, the time of the call, the user ID, a code identifying the call campaign associated with the call, duration of the call, whether the call was picked up by the correct party, etc.

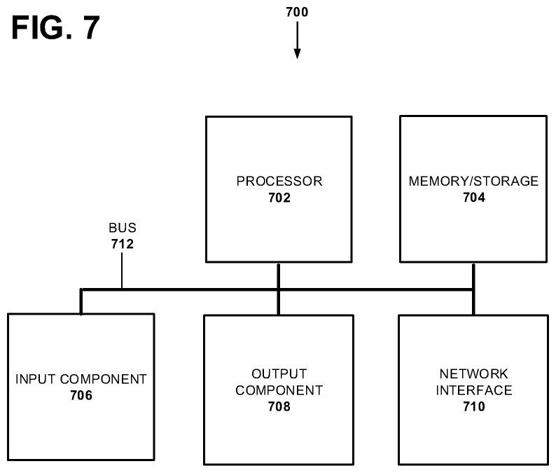

FIG. 7 depicts exemplary components of an exemplary network device 700. Network device 700 corresponds to or is included in devices 102, intelligent calling system 106, routers, switches, and/or any of the network components of FIG. 1. As shown, network device 700 includes a processor 702, memory/storage 704, input component 706, output component 708, network interface 710, and bus 712. In different implementations, network device 700 may include additional, fewer, different components than the ones illustrated in FIG. 7.

Processor 702 may include a processor, a microprocessor, an Application Specific Integrated Circuit (ASIC), a Field Programmable Gate Array (FPGA), a programmable logic device, a chipset, an application specific instruction-set processor (ASIP), a system-on-chip (SoC), a central processing unit (CPU) (e.g., one or multiple cores), a microcontroller, and/or another processing logic device (e.g., embedded device) capable of controlling network device 700 and/or executing programs/instructions.

Memory/storage 704 may include static memory, such as read only memory (ROM), and/or dynamic memory, such as random access memory (RAM), or onboard cache, for storing data and machine-readable instructions (e.g., programs, scripts, etc.).

Memory/storage 704 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 704 may be external to and/or removable from network device 700. Memory/storage 704 may include, for example, a Universal Serial Bus (USB) memory stick, a dongle, a hard disk, off-line storage, a Blu-Ray® disk (BD), etc. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 706 and output component 708 may provide input and output from/to a user to/from network device 700. Input and output components 706 and 708 may include, for example, a display screen, a keyboard, a mouse, a speaker, actuators, sensors, gyroscope, accelerometer, a microphone, a camera, a DVD reader, Universal Serial Bus (USB) lines, and/or other types of components for obtaining, from physical events or phenomena, to and/or from signals that pertain to network device 700.

Network interface 710 may include a transceiver (e.g., a transmitter and a receiver) for network device 700 to communicate with other devices and/or systems. For example, via network interface 710, network device 700 may communicate with access station 210. Network interface 710 may include an Ethernet interface to a LAN, and/or an interface/connection for connecting network device 700 to other devices (e.g., a Bluetooth interface). For example, network interface 710 may include a wireless modem for modulation and demodulation.

Bus 712 may enable components of network device 700 to communicate with one another.

Network device 700 may perform the operations described herein in response to processor 702 executing software instructions stored in a non-transient computer-readable medium, such as memory/storage 704. The software instructions may be read into memory/storage 704 from another computer-readable medium or from another device via network interface 710. The software instructions stored in memory or storage (e.g., memory/storage 704, when executed by processor 702, may cause processor 702 to perform processes that are described herein. For example, UE 106 and FWA 108 each include various programs for performing some of the above-described functions and processes.

In this specification, various preferred embodiments have been described with reference to the accompanying drawings. Modifications may be made thereto, and additional embodiments may be implemented, without departing from the broader scope of the invention as set forth in the claims that follow. The specification and drawings are accordingly to be regarded in an illustrative rather than restrictive sense. For example, while a series of blocks have been described above with regard to the process illustrated in FIG. 6, the order of the blocks may be modified in other implementations. In addition, non-dependent blocks may represent actions that can be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store, or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
generate training vectors based on data related to communication with users;
convert the training vectors into optimized vectors to be input into a machine learning unit;
apply the machine learning unit to the optimized vectors to construct decision trees for determining probabilities of making a successful call during different time windows;
generate a list of calls and calling times based on the determined probabilities; and
send the list to an automatic dialer,
wherein the automatic dialer is configured to:
receive the list; and
place calls identified in the list at the call times.

2. The device of claim 1, wherein each of the training vectors includes:
a target vector that indicates whether a successful call has been made during one of a predetermined number of time windows.

3. The device of claim 2, wherein the time windows include:
an early morning time interval;
a morning time interval;
an afternoon time interval; and
an evening time interval.

4. The device of claim 1, wherein the data is stored in at least one of:
a first database that includes first information related to an account held by a user subscribed to a service provider; or
a second database that includes second information about phone calls to users.

5. The device of claim 4, wherein the successful call includes:
a telephone call that was picked up by the user; or
a telephone call that resulted in the user making a payment to the service provider.

6. The device of claim 4, wherein the first information includes one or more of:
a time zone associated with the user; or
a credit score,
wherein the second information includes:
a time of a call made to the user.

7. The device of claim 1, wherein when the processor generates the training vectors, the processor is configured to:
derive first vectors based on the data;
split each of the first vectors into at least a third vector and a fourth vector;
obtain an expanded vector by increasing a width of the third vector; and
obtain a filled vector by filling in any missing datum, in the fourth vector, with an average value of the fourth vectors.

8. The device of claim 7, wherein the expanded vector includes:
a number of attributes equal to a maximum number of categories that all attributes of the third vector can denote.

9. The device of claim 1, wherein one of the constructed decision trees comprises at least:
a decision node that represents a test condition based on an attribute of the optimized training vectors; and
a leaf node that represents a successful call at a particular time window.

10. The device of claim 1, wherein the machine learning unit is configured to:
apply a learning rate of 0.1; and
generate 100 decision trees, wherein each of the decision trees includes 31 leaves and 6 layers.

11. A method comprising:
generating training vectors based on data related to communication with users;
converting the training vectors into optimized vectors to be input into a machine learning unit;
applying the machine learning unit to the optimized vectors to construct decision trees for determining probabilities of making a successful call during different time windows;
generating a list of calls and calling times based on the determined probabilities; and
forwarding the list to an automatic dialer,
wherein the automatic dialer is configured to:
receive the list; and
place calls identified in the list at the call times.

12. The method of claim 11, wherein each of the training vectors includes:
a target vector that indicates whether a successful call has been made during one of a predetermined number of time windows.

13. The method of claim 11, wherein the time windows include:
an early morning time interval;
a morning time interval;
an afternoon time interval; and
an evening time interval.

14. The method of claim 11, wherein the data is stored in at least one of:
a first database that includes first information related to an account held by a user subscribed to a service provider; and
a second database that includes second information about phone calls to users.

15. The method of claim 14, wherein the successful call includes:
a telephone call that was picked up by the user; or
a telephone call that resulted in the user making a payment to the service provider.

16. The method of claim 14, wherein the first information includes one or more of:
a time zone associated with the user; or
a credit score,
wherein the second information includes:
a time of a call made to the user.

17. The method of claim 11, wherein generating the training vectors includes:
deriving first vectors based on the data;
splitting each of the first vectors into at least a third vector and a fourth vector;
obtaining an expanded vector by increasing a width of the third vector; and
obtaining a filled vector by filling in any missing datum, in the fourth vector, with an average value of the fourth vectors.

18. The method of claim 17, wherein the expanded vector includes:
a number of attributes equal to a maximum number of categories that all attributes of the third vector can denote.

19. The method of claim 11, wherein one of the constructed decision trees comprises at least:
a decision node that represents a test condition based on an attribute of the optimized training vectors; and
a leaf node that represents a successful call at a particular time window.

20. A non-transitory computer-readable medium comprising processor executable instructions, which when executed by a processor, cause the processor to:
generate training vectors based on data related to communication with users;
convert the training vectors into optimized vectors to be input into a machine learning unit;
apply the machine learning unit to the optimized vectors to construct decision trees for determining probabilities of making a successful call during different time windows;
generate a list of calls and calling times based on the determined probabilities; and
send the list to an automatic dialer,
wherein the automatic dialer is configured to:
receive the list; and
place calls identified in the list at the call times.
